(19) United States
(12) Patent Application Publication
(10) Pub. No.: US 2011/0241966 A1
(43) Pub. Date: Oct. 6, 2011

(54) ANTENNA HOUSING FOR SUPRESSING BACKWARD RADIATION

(75) Inventors: Dong-Ho KIM, Daejeon (KR); Jae-Ick Choi, Daejeon (KR); Hyung-Ki Lee, Gyeonggi-do (KR)

(73) Assignee: ELECTRONICS AND TELECOMMUNICATIONS RESEARCH INSTITUTE, Daejeon (KR)

(21) Appl. No.: 12/942,541

(22) Filed: Nov. 9, 2010

(30) Foreign Application Priority Data
Mar. 31, 2010 (KR) 10-2010-0029488

(51) Int. Cl. H01Q 1/48

(52) U.S. Cl. 343/848

(57) ABSTRACT

An antenna housing includes a primary reflector attached to a PCB having a radiation device pattern formed on the PCB; and a secondary reflector positioned behind the primary reflector so as to maintain a predetermined distance from the primary reflector.

### CROSS-REFERENCE(S) TO RELATED APPLICATIONS

The present application claims priority of Korean Patent Application No. 10-2010-0029488, filed on Mar. 31, 2010, which is incorporated herein by reference in its entirety.

### BACKGROUND OF THE INVENTION

1. Field of the Invention

Exemplary embodiments of the present invention relate to an antenna housing; and, more particularly, to an antenna housing for suppressing backward radiation.

2. Description of Related Art

In general, a cellular system has large cells arranged in a number of places, and the cells are used for communication so that a number of users simultaneously connected to the communication network are provided with a communication service. In Korea, for example, SK Telecom currently uses 800 MHz band to provide a cellular service.

A communication network using such a cellular system operates base stations or repeaters, which constitute respective cells. The base stations or repeaters commonly employ array antennas, which include a number of radiation devices arranged in the vertical or horizontal direction. Specifically, for efficient space utilization, antennas are manufactured so as to suppress backward directivity.

However, conventional array antennas for base stations or repeaters have a problem in that, in order to suppress backward directivity, individual radiation devices or respective groups of radiation devices are installed to protrude forward from the reflection plate. This complicates the manufacturing process, specifically the process of wiring the antenna circuit board, and increases the manufacturing cost. Furthermore, the fact that respective operators are given different wiring conditions results in uneven characteristics.

Therefore, there is a need for an alternative approach for suppressing backward directivity of antennas and improving forward directivity.

### SUMMARY OF THE INVENTION

An embodiment of the present invention is directed to an antenna housing configured to suppress backward directivity of the antenna efficiently without requiring a process of complicated wiring on a PCB.

Another embodiment of the present invention is directed to an antenna housing configured to suppress backward radiation efficiently without a specific manufacturing process for radiation devices protruding from a reflection plate, thereby reducing the manufacturing cost.

Another embodiment of the present invention is directed to an antenna housing having a stable reflector structure configured to stabilize backward radiation suppression characteristics.

Other objects and advantages of the present invention can be understood by the following description, and become apparent with reference to the embodiments of the present invention. Also, it is obvious to those skilled in the art to which the present invention pertains that the objects and advantages of the present invention can be realized by the means as claimed and combinations thereof.

In accordance with an embodiment of the present invention, an antenna housing includes: a primary reflector attached to a PCB having a radiation device pattern formed on the PCB; and a secondary reflector positioned behind the primary reflector so as to maintain a predetermined distance from the primary reflector.

### BRIEF DESCRIPTION OF THE DRAWINGS

FIG. 1 is a conventional circuit diagram of an array antenna for a mobile communication base station.

FIG. 2 is a three-view orthographic projection of a conventional antenna housing including a primary reflector only.

FIG. 3 is a three-view orthographic projection of an antenna housing including double reflectors in accordance with an embodiment of the present invention.

FIGS. 4 to 7 are graphs illustrating comparisons of directivity and gain of an array antenna between when the antenna housing includes a primary reflector only and when a secondary reflector in accordance with the present invention is also included, specifically:

FIG. 4 is a graph illustrating a comparison of vertical-direction radiation directivity of the antenna.

FIG. 5 is a graph illustrating a comparison of horizontal-direction radiation directivity of the antenna.

FIG. 6 is a graph illustrating a comparison of vertical-direction radiation gain of the antenna.

FIG. 7 is a graph illustrating a comparison of horizontal-direction radiation gain of the antenna.

### DESCRIPTION OF SPECIFIC EMBODIMENTS

Exemplary embodiments of the present invention will be described below in more detail with reference to the accompanying drawings. The present invention may, however, be embodied in different forms and should not be constructed as limited to the embodiments set forth herein. Rather, these embodiments are provided so that this disclosure will be thorough and complete, and will fully convey the scope of the present invention to those skilled in the art. Throughout the disclosure, like reference numerals refer to like parts throughout the various figures and embodiments of the present invention.

The present invention is directed to an antenna housing for an array antenna used by a base station or a repeater in a mobile communication network, which suppresses backward directivity of the antenna and improves forward directivity, and which includes double reflectors designed for easy manufacturing. An antenna housing in accordance with an exemplary embodiment of the present invention will now be described in detail with reference to the accompanying drawings.

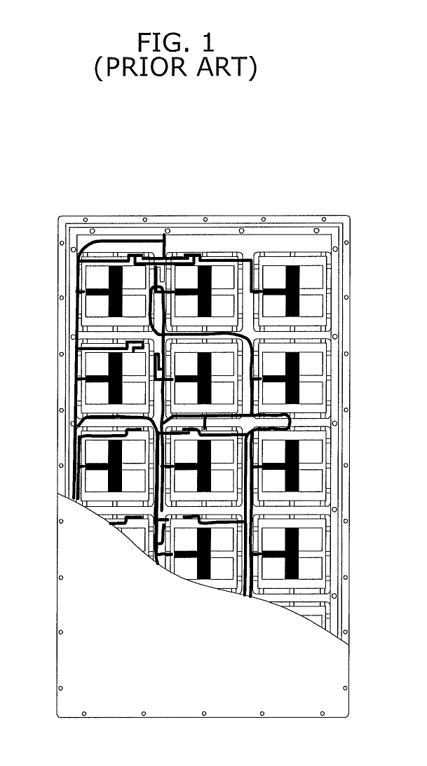

FIG. 1 is a conventional circuit diagram of an array antenna for a mobile communication base station.

Referring to FIG. 1, an array antenna for a base station commonly employs 3×5 array, and an array antenna for a repeater commonly employs 3×4 array, the size depending on the employed array. That is, the array antenna for a repeater is based on the same principle as that for a base station, except for the size that depends on the array. Therefore, it will be assumed in the following description of an embodiment of the present invention that the array antenna employs 3×5 array.

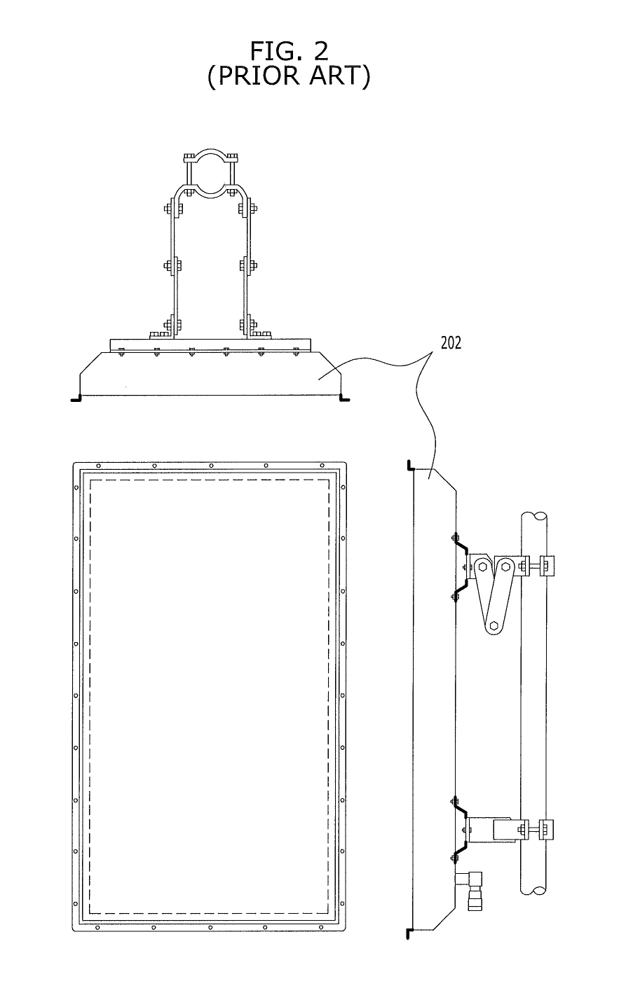

FIG. 2 is a three-view orthographic projection of a conventional antenna housing including a primary reflector only. Specifically, FIG. 2 includes a top view on the upper left side, a front view on the lower left side, and a side view on the lower right side.

Referring to FIG. 2, the primary reflector 202 is configured to protect internal antenna devices and suppress backward radiation. It is to be noted, however, that use of the primary reflector alone results in poorer backward radiation suppression performance than when a secondary reflector is also used in accordance with the present invention. Furthermore, the process for complicated wiring of radiation devices, which is needed to improve the antenna performance, increases the manufacturing cost.

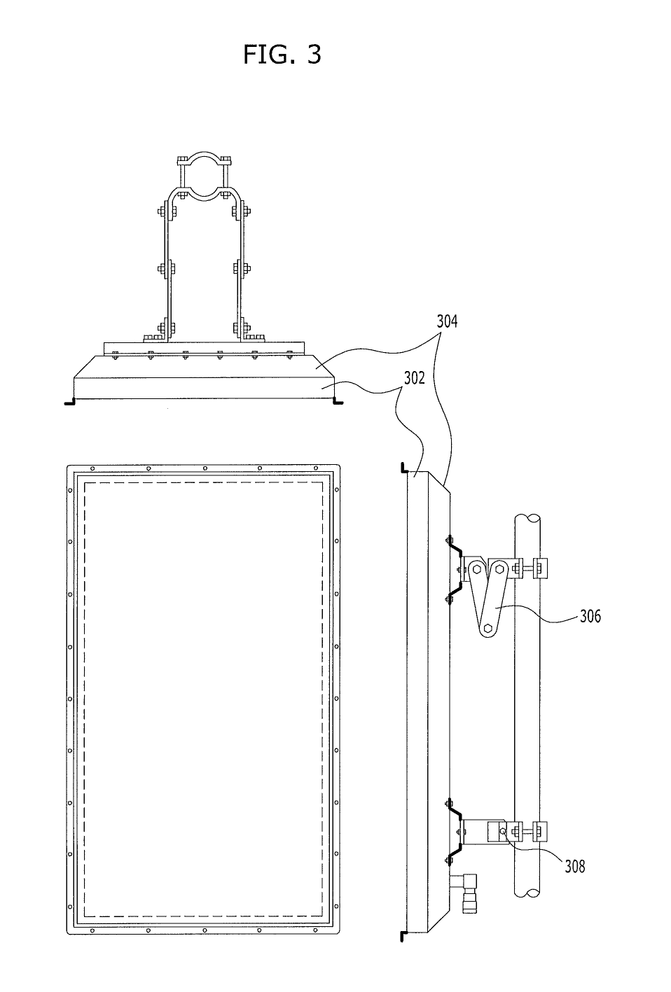

FIG. 3 is a three-view orthographic projection of an antenna housing including double reflectors in accordance with an embodiment of the present invention. Specifically, FIG. 3 includes a top view on the upper left side, a front view on the lower left side, and a side view on the lower right side.

Referring to FIG. 3, the antenna housing in accordance with an embodiment of the present invention includes a primary reflector 302 attached to a PCB, on which a radiation device pattern is formed, a secondary reflector 304 positioned behind the primary reflector 302 so as to maintain a predetermined distance from the primary reflector 302, and at least one fastener 306 and 308 configured to fasten the secondary reflector 304 onto a support table.

The primary and secondary reflectors 302 and 304 may be made of a metallic conductor and are configured to protect and support internal antenna devices and serve as a reflecting plate suppressing backward radiation.

The secondary reflector 304 of the array antenna in accordance with this embodiment has the shape of a quadrilateral tube having lateral walls slanted at a predetermined angle, and is configured to further improve backward radiation suppression characteristics of the antenna together with the primary reflector 302. The secondary reflector 304 is shaped to surround the primary reflector 302 from behind the primary reflector 302, and may be attached to a PCB inside the antenna housing or to the primary reflector 302.

The fasteners 306 and 308 are configured to fix the double-reflector antenna housing to a support table. Each fastener is fixed to the support table by a clamp, for example. The upper fastener 306 may be implemented with a rotatable link structure so that, during antenna installation, the angle can be adjusted. Those skilled in the art can understand that, although two fasteners are fastened to the upper and lower sides so as to adjust the angle of the antenna housing in the vertical direction in accordance with this embodiment, other types of fastener arrangements are also possible, e.g. a single fastener may be attached to the rear center of the secondary reflector and enable 360° rotation in either vertical or horizontal direction.

The antenna housing in accordance with this embodiment may further include a cover attached to the front of the primary reflector to protect the internal PCB.

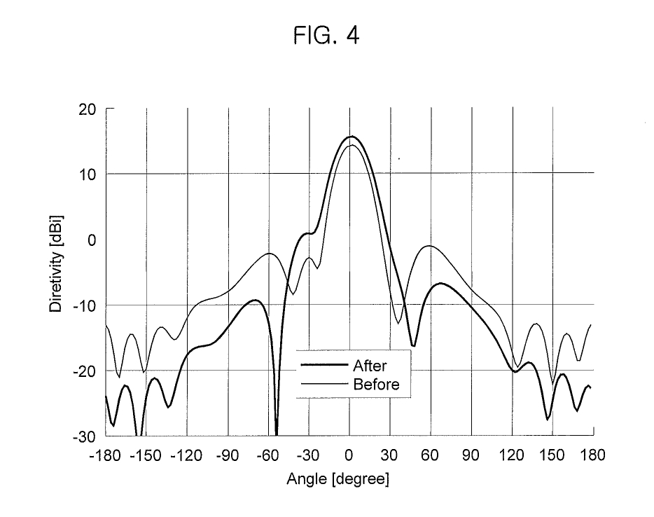

FIGS. 4 to 7 are graphs illustrating comparisons of directivity and gain of an array antenna between when the antenna housing includes a primary reflector only and when a secondary reflector in accordance with the present invention is also included. In the graphs, lines labeled “Before” correspond to the case of a primary reflector alone, and lines labeled “After” correspond to the case of both primary and secondary reflectors. Simulation settings of the antenna housing in accordance with the present invention are, referring to FIG. 3, as follows: the primary reflector 302 has a height of 39 mm, the secondary reflector 304 has a height (distance between the primary and secondary reflectors) of 46.9 mm, and the secondary reflector 304 has a lateral wall angle of 135°.

FIG. 4 is a graph illustrating a comparison of vertical-direction radiation directivity of the antenna.

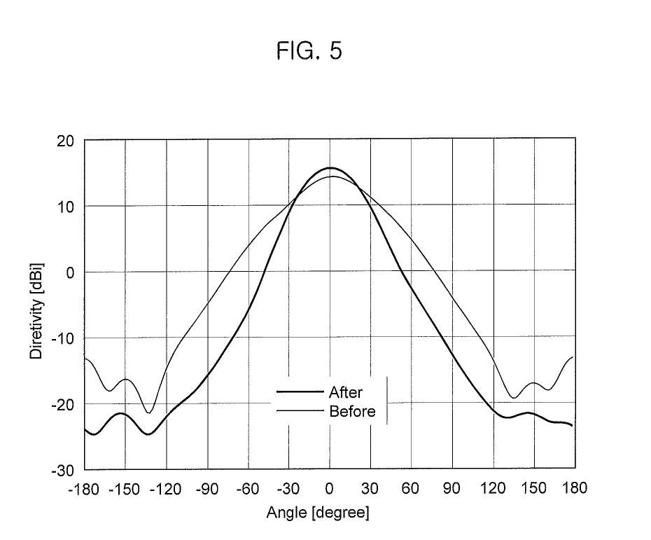

FIG. 5 is a graph illustrating a comparison of horizontal-direction radiation directivity of the antenna.

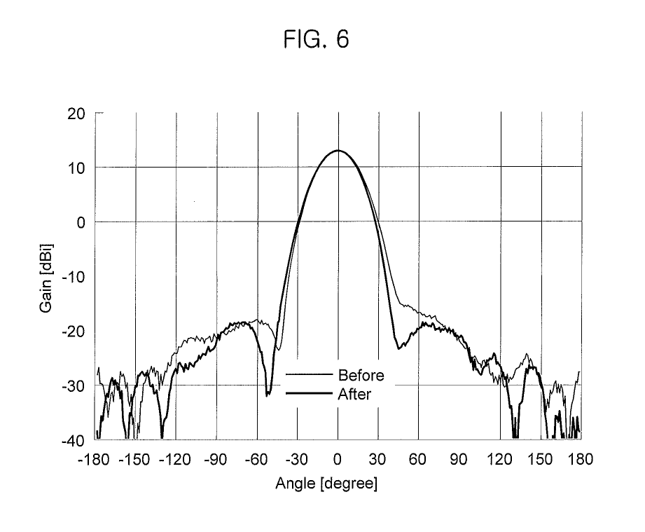

FIG. 6 is a graph illustrating a comparison of vertical-direction radiation gain of the antenna.

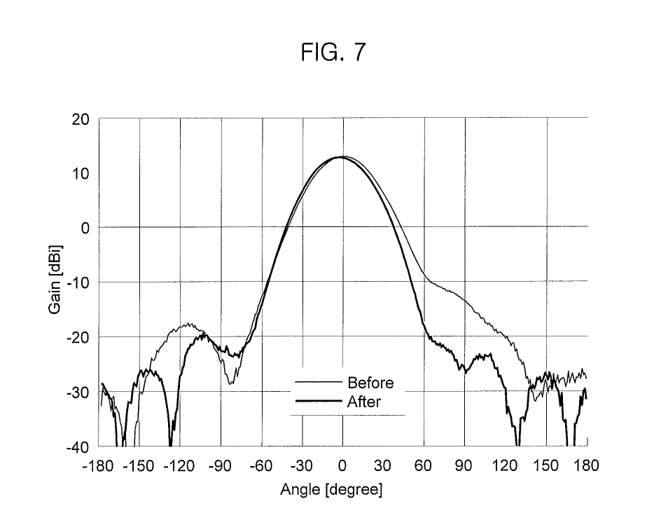

FIG. 7 is a graph illustrating a comparison of horizontal-direction radiation gain of the antenna.

It is clear from FIGS. 4 and 5 that use of an antenna housing including double reflectors in accordance with the present invention has increased radiation directivity in the ranges of 0˜ about ±40° in the vertical direction and about ±30° in the horizontal direction, with directivity in other directions reduced.

It is clear from FIGS. 6 and 7 that use of an antenna housing including double reflectors in accordance with the present invention has barely changed radiation gain in the ranges of 0˜ about ±30° in both vertical and horizontal directions, with directivity in other directions further reduced.

In other words, the graphs of FIGS. 4 to 7 show further improved forward directivity of the antenna and suppressed backward directivity.

In accordance with the exemplary embodiments of the present invention, backward directivity of the antenna is suppressed efficiently without requiring a process of complicated wiring on a PCB. In addition, backward radiation is suppressed efficiently without a specific manufacturing process for radiation devices protruding from a reflection plate, thereby reducing the manufacturing cost. Furthermore, the stable reflector structure stabilizes backward radiation suppression characteristics.

While the present invention has been described with respect to the specific embodiments, it will be apparent to those skilled in the art that various changes and modifications may be made without departing from the spirit and scope of the invention as defined in the following claims.

What is claimed is:

1. An antenna housing comprising:
a primary reflector attached to a PCB having a radiation device pattern formed on the PCB; and
a secondary reflector positioned behind the primary reflector so as to maintain a predetermined distance from the primary reflector.

2. The antenna housing of claim 1, wherein the primary or secondary reflector is made of a metallic conductor.

3. The antenna housing of claim 1, wherein the secondary reflector has a shape of a quadrilateral tube having lateral walls slanted at a predetermined angle.

4. The antenna housing of claim 1, wherein the secondary reflector has a feeding connector connected to a rear surface.

5. The antenna housing of claim 1, wherein the secondary reflector is attached to the primary reflector or the PCB so as to surround the primary reflector.

6. The antenna housing of claim 1, further comprising at least one fastener configured to fasten the secondary reflector to a support table.

7. The antenna housing of claim 6, wherein the fastener comprises a rotatable link structure.

8. The antenna housing of claim 1, further comprising a cover attached to a front surface of the primary reflector to protect the internal PCB.
